(19) United States
(12) Patent Application Publication
(10) Pub. No.: US 2016/0063085 A1
(43) Pub. Date: Mar. 3, 2016

(54) SYSTEM AND METHOD FOR ANTICIPATING CRIMINAL BEHAVIOUR

(71) Applicant: Peter Antonius Maria Gerardus DE KOCK, Hilversum (NL)

(72) Inventor: Peter Antonius Maria Gerardus DE KOCK, Hilversum (NL)

(21) Appl. No.: 14/474,681

(22) Filed: Sep. 2, 2014

(51) Int. Cl. G06F 17/30; G06F 3/0481

(52) U.S. Cl. CPC G06F 17/30598; G06F 3/0481; G06F 17/30477

(57) ABSTRACT

A system and method for anticipating criminal behaviour. The system includes or is connectable to a database including records, each record including data representative of a criminal incident. The system includes a pre-processing unit arranged for scanning each record for identifying data-items relating to a plurality of predetermined data types, wherein the plurality of predetermined data types includes all or a sub-set of: Arena, Time(frame), Context, Protagonist, Antagonist, Motivation, Primary Objective, Means, modus operandi, Resistance, Symbolism, and Red herring of the criminal incident. The system includes a classifying unit arranged for assigning to each identified data-item a category value of one of a plurality of predetermined category values associated with said predetermined data-type. The system includes a processing unit arranged for constructing a matrix containing a row for each record, and containing columns related to the predetermined data-types, the cells of the matrix containing the determined category values. The system includes an input unit, arranged for receiving user input, the user input including category values of a criminal incident for some, but not all, of the predetermined data types. The system includes a scenario generator arranged for estimating, on the basis of the user input and on the basis of the matrix, a category value for the predetermined data type(s) not included in the user input. The system includes an output unit arranged for outputting the estimated category value for the predetermined data type(s) not included in the user input.

### FIELD OF THE INVENTION

The present invention relates to a system and a computer implemented method for efficiently rendering unstructured data suitable for rapid and complex inspection. More specifically, the invention relates to a system and a computer implemented method for anticipating criminal behaviour.

### BACKGROUND TO THE INVENTION

Much data is being generated and stored every day. Since the 1980's the world's capacity to digitally store information has increased by over twenty percent per year. One of the great challenges is to be able to handle the large amounts of data and still efficiently find the data or connections you are looking for. This is often made even more challenging by the fact that much data is heterogeneous in nature.

Law enforcement, as any other discipline, faces these challenges. Intelligence and counter-terrorism to a large extent rely on the amount and quality of data they uncover and on the personal skills of highly trained officers to analyze that data and assign predictive value to it.

It is the aim of the invention to automate at least large parts of this process. Moreover, it is an aim of the invention to provide a system and a method that more efficiently copes with heterogeneous data, so as to be able to better and quicker anticipate criminal behaviour.

### SUMMARY OF THE INVENTION

Narratives play an important role in human life. Narratives help people to understand the world around them, and to grasp complex concepts such as ethics and morality. The need for narrative is rooted so deep in human existence that narratives are at the mainstay of entertainment, law, and politics. In the creative sector, a narrative is generated by a scenario that describes the interactions between characters. It includes information about behaviour, goals, motivations, modi operandi, and resistances that have to be overcome. Both a theatrical performance and a criminal offence are choreographed productions and there is a strong analogy between the ways a theatrical performance and a criminal offence develop. The inventor realized that the elements that make up a scenario and those that make up a terrorist act, are correlated. Hence, criminal behaviour can be modelled based on the way human behaviour is modelled in creative scenario writing. The inventor realized that by thus analyzing scenarios of criminal incidents it should be possible to predict or estimate missing pieces of information in certain scenarios. It should also be possible to do this in an automated way. Preferably human intervention would be minimized.

Thereto, according to the invention is provided a system for anticipating criminal behaviour. The system includes an interface unit that is arranged for receiving records from a database including a plurality of records, each record including data representative of a criminal incident. The database may also be part of the system. The system further includes a pre-processing unit arranged for scanning each record for identifying data-items relating to a plurality of predetermined data types. The plurality of predetermined data types includes all or a sub-set of: Arena, Time(frame), Context, Protagonist, Antagonist, Motivation, Primary Objective, Means, modus operandi, Resistance, Symbolism, and Red herring of the criminal incident. The system further includes a classifying unit arranged for assigning to each identified data-item a category value of one of a plurality of predetermined category values associated with said predetermined data-type. The system further includes a processing unit arranged for constructing a matrix containing a row for each record, and containing columns related to the predetermined data-types, the cells of the matrix containing the determined category values. The system further includes an input unit, arranged for receiving user input. The user input includes category values of a criminal incident for some, but not all, of the predetermined data types. The system further includes a scenario generator arranged for estimating, e.g. on the basis of the user input and on the basis of the matrix, a category value for the predetermined data type(s) not included in the user input. The system further includes an output unit, arranged for outputting the estimated category value for the predetermined data type(s) not included in the user input.

It is noted that the invention is also subject of a Ph.D. thesis relating to research performed by the inventor at Tilburg University under supervision of Prof dr. H. J. van den Herik. The thesis is titled “Anticipating Criminal Behaviour: using the narrative in crime-related data” and is incorporated herein by reference.

It is known that scenarios contain several fixed components. The ancient rhetorician Hermagoras of Temnos (first century BC) defined the following elements of a scenario: quis, quid, quando, ubi, cur, quem ad modum, quibus adminiculis. These elements can be translated as: Who is it about? What did happen? When did it take place? Where did it take place? Why did it happen? In what way did it happen? By what means did it happen? The latter are often referred to as “the golden W's”.

The inventor realized that these golden W's do not offer components sufficiently durable to describe, characterize and model a scenario, nor a criminal act. Therefore, the inventor identified a novel set of data types which highly increase the analytic value and predictive value of scenarios of criminal incidents when breaking down the scenarios in terms of these data types.

Moreover, the inventor realized that automated analysis of large quantities of narratives of criminal incidents would increase the predictive power. By defining for each data type a plurality of predetermined category values, the information content of the narrative is stylized in that for that particular data type—the actual textual content of the narrative is classified according to a predefined breakdown of that data type. Accordingly, the information content of the narrative is stylized in that for the totality of the predetermined data types the actual textual content of the narrative is classified according to a predefined breakdown of the data types. Examples of this will be given below. The use of data types and predetermined category values also provides the advantage that the multitude of narratives contained in the records of the database can be summarized as a set of category values, e.g. integer values, representing the different data types. This allows for the multitude of narratives to be stored in matrix format. This saves storage space and processing power when processing the multitude of narratives. This also allows for complex operations to be performed on the narratives.

It will be appreciated that the data stored in the matrix, and hence that data retrieved from the database (or from a plurality of databases) need not necessarily relate to actual real-life events. In addition to, or as an alternative to, data relating to real-life criminal incidents, the database(s), and hence the matrix, may also include data relating to fictitious criminal incidents. It is for instance possible to include data related to works of fiction, such as movie scripts, theater productions or novels having a criminal incident as subject, in the matrix. As described above, both scenarios of criminal incidents from works of fiction, and real-life criminal incidents, include the same constituents, and both can be described in terms of the data types described herein. Combining data from fictional criminal behaviour with data from real life criminal behaviour can enhance the efficiency of the system.

The plurality of data types includes all or a sub-set of: Arena, Time(frame), Context, Protagonist, Antagonist, Motivation, Primary Objective, Means, modus operandi, Resistance, Symbolism, Red herring of the criminal incident. It is possible that the pre-processing unit has all these data types defined, and that a user of the system can select, e.g. via a user interface, which of these data types to use. It is possible that the pre-processing unit has all these data types defined in a memory, It is possible that the pre-processing unit only uses the data types that are encountered in the scanned data records. Optionally, the plurality of data types includes Protagonist and Antagonist. Optionally, the plurality of data types includes Arena, Protagonist, Antagonist, and Means. Optionally, the plurality of data types includes Arena, Protagonist, Antagonist, Motivation, Means, modus operandi. Optionally, the plurality of predetermined data types includes: Arena, Time(frame), Context, Protagonist, Antagonist, Motivation, Primary Objective, Means, modus operandi, Resistance. Optionally, the plurality of predetermined data types includes: Arena, Time(frame), Context, Protagonist, Antagonist, Motivation, Primary Objective, Means, modus operandi, Resistance, Symbolism, Red herring.

These twelve data types, herein also referred to as Elementary Scenario Components (herein also referred to as “ESC12”), can be described as follows.

1 Arena

The objective Elementary Scenario Component Arena refers to the physical location where an incident takes place. It may refer to a geographic location or a type of environment such as an urban or rural surrounding.

2 Time(frame)

The objective Elementary Scenario Component Timeqrame) refers to the time or timeframe in which an incident takes place. For instance, a story can evolve within a timeframe of seconds as well as over a period of many years.

3 Context

The objective Elementary Scenario Component Context refers to the set of circumstances that surround the incident. It provides for actions to be appreciated within a social, cultural, or political background.

4 Protagonist

The objective Elementary Scenario Component Protagonist refers to the main character in the scenario. According to the rules of creative scenarios, the plot revolves around the Protagonist, the central component within the set of data types.

5 Antagonist

The objective Elementary Scenario Component Antagonist represents the opposition against which the Protagonist must contend. The Antagonist in a scenario can be a person, a group of people, an institution, or a society, but also a situation, an animal, or an object.

6 Motivation

The subjective Elementary Scenario Component Motivation refers to the psychological features that drive the Protagonist toward a desired goal. Motivation may be rooted in a basic impulse to optimise well-being, to minimize physical pain, or to maximize pleasure. Motivation generally can be classified into five categories: Need, Greed, Power, Moral outrage, and Glory.

7 Primary objective

The subjective Elementary Scenario Component Primary objective refers to the primary objective of the Protagonist. It may be seen as a way by which the Protagonist attains his motivation. The Elementary Scenario Component Primary objective is subjective in the sense that it is often not explicitly expressed, but rather related to the motivation of the Protagonist.

8 Means

The objective Elementary Scenario Component Means refers to the method(s) or instrument(s) of the Protagonist to obtain a result or achieve an objective. Means in scenario writing generally is closely connected to the primary objective of the Protagonist.

9 Modus operandi

The objective Elementary Scenario Component Modus operandi refers to the method of operation of the Protagonist. The Modus operandi often constitutes an elaborate set of manners employed by the Protagonist.

10 Resistance

The objective Elementary Scenario Component Resistance refers to all the obstacles that the Protagonist has to overcome to attain his goal.

11 Symbolism

The interpretative Elementary Scenario Component Symbolism stands for one thing represented by another (by means of association, resemblance, or convention). Symbolism needs interpretation by (a member of) the audience or any other person involved. To put it in other words, Symbolism lies in the eye of the beholder.

12 Red herring

The interpretative Elementary Scenario Component Red herring can be regarded a false clue, designed to mislead the audience or any other person involved.

The predetermined data types can be divided into three categories: (1) objective, (2) subjective, and (3) interpretable components. The objective components constitute observable phenomena and are not related to the protagonist's individual feelings, imaginations, or interpretations. The objective components are Arena, Time(frame), Context, Protagonist, Antagonist, Means, Modus operandi, and Resistance. The subjective components, in contrast, pertain to the conception of the protagonist of the story. They reflect his individual interpretations of experiences consisting of emotional, intellectual, and spiritual perceptions as well as misperceptions. The subjective components are Motivation and Primary objective. The interpretable components are components that do not have a meaning until they are given an interpretation by a third party, i.e., the audience, investigator, or the operator of the system. The interpretable Elementary Scenario Components are Symbolism and Red herring.

We note that six of these twelve data types are not included in the Golden W's. Four of the most obvious ones are: Context, Antagonist, Motivation, and Resistance. The Context of an incident can be quintessential in the validation of information. Additionally, the Antagonist in a narrative carries a responsibility for the plot, just as a victim does in a violent crime. Moreover, criminal theories suggest that the components Context, Primary objective, Motivation, Resistance, and Antagonist can be essential in the understanding of criminal behaviour. Therefore, including some or all of these data types can provide a huge benefit over use of “the Golden W's”.

Next to the Elementary Scenario Components Context, Antagonist, Motivation, and Resistance two more of these twelve data types are missing in the Golden W's, viz. Symbolism, and Red herring. These data types can carry an added value in crime research. Appreciating the role of Symbolism, and Red herring in describing a criminal act might provide valuable insights into the predicaments of criminal behaviour.

It is noted that the “Plot” is a logical sequence of events that grows from an initial incident and alters the status (quo) of the characters. In a narrative, the plot is the causal relation of the twelve data types. For instance, in Escape from Alcatraz (Paramount Pictures, 1979), the Arena of the narrative explains the relation between the Protagonists (inmates that became befriended) and the Antagonist (the physical obstacles represented by the prison of Alcatraz, its guards, and—to a lesser extent—San Francisco Bay). Also, the elaborate Modus operandi, which constitutes the use of spoons to dig through concrete walls as well as the fabrication of a Red herring (dummy heads created from a mixture of soap, paper, and real hair), has a causal relation to the limited Means the prisoners had. As the example of Escape from Alcatraz indicates, the plot is not a data type in itself but merely refers to the causal relation of the individual twelve data types. Although the plot of a narrative is usually quite elaborate, it can be compared to the question “What did happen?”

In the attacks of Sep. 11, 2001, the symbolic value of the targets (Antagonists) may have most likely been an important factor in the process of target selection. The World Trade towers were seen as a symbol for the financial and economic power while the Pentagon was regarded as a symbol for the military power of the USA.

The videotape that was found after the bomb attack on Rafiq Hariri in Lebanon on Feb. 14, 2005, suggested an Al Qaeda related Terrorist organisation was responsible for the attack. However, weeks later it turned out that the Modus operandi of the Protagonist had included a Red herring and no Al Qaeda related cell carried responsibility for the attack.

As illustrated by the aforementioned examples, the Elementary Scenario Components Modus operandi or Antagonist may include a symbolic value or a Red herring. However, not every Elementary Scenario Component can be affected by these components.

Optionally, the scenario generator that is part of the system is arranged for estimating, e.g. on the basis of the user input and on the basis of the matrix, a plurality of category values for the predetermined data type(s) not included in the user input, preferably each with an associated level of confidence. Additionally, the scenario generator can be designed to harvest knowledge from the accumulated scenarios, and to use that knowledge in generating new scenarios. When estimating a plurality of category values for each of the data types not included in the user input, a list of potential category values for each such data type can be generated. The list can be used as input for further investigation, providing a list of most likely values for these data types. Preferably a level of confidence is associated with each estimated category value. The level of confidence (which may be displayed by a percentage), refers to a measure of reliability of the result. The level of confidence can, e.g. statistically, be determined on the basis of the data accumulated in the matrix. Moreover, the list may be ranked according to likelihood.

Optionally, the system further includes an analyzer unit arranged for analyzing the matrix for determining (a) intra-scenario relationships between category values of different data types within a scenario, and/or (b) inter-scenario relationships between category values of the same data type between scenarios. For instance, intra-scenario relationships may reveal a correlation between a certain category value of the first data type and another category value of a second data type, within the same scenario. Inter-scenario relationships, on the other hand, may reveal a correlation between a certain category value of a certain data type, in more than one scenario.

Optionally, the a scenario generator is arranged for estimating a category value for the predetermined data type(s) that are not included in the user input, on the basis of the user input and on the basis of the intra-scenario and/or inter-scenario relationships.

Optionally, the system further includes an analyzer unit arranged for interpreting the user input as a vector, for interpreting each row of the matrix as a vector, and for determining the row(s) having an associated vector ending at a Euclidian distance from the endpoint of the vector associated with the user input, such that this distance is smaller than a predetermined threshold value. Optionally, such analyzer unit is further arranged for determining the row(s) in the matrix having an associated vector ending at the smallest Euclidian distance from the endpoint of the vector associated with the user input.

Optionally, at least one of the data types of the plurality of predetermined data types includes a plurality of sub data types, each sub data type having a plurality of predetermined category values associated therewith.

The inventor realised that most human behaviour can be described in narratives. Therefore, such narratives relating to human behaviour can be mapped onto the predetermined data types defined herein. Hence, these narratives can be broken down into category values relating to the twelve Elementary Scenario Components, or to category values relating to a subset of these twelve Elementary Scenario Components. Since any narrative can be constructed from a combination of the ESC12, the system as described above, can also be used for analysing and/or anticipating human behaviour in other fields than criminal behaviour. By means of non-limiting examples, here are mentioned human behaviour in the fields of tourism, travelling, insurance, fraud, negotiation, litigation, gaming industry, consumer behaviour, politics, warfare, geopolitical developments, etc.

Hence, according to an aspect of the invention, a system for analysing and/or anticipating behaviour is provided. The system includes or is arranged to be communicatively connected to a database including records, each record including data representative of an event. Such events can be criminal incidents, but can thus also be fraud cases, travel information, court cases, consumer behaviour tests, computer games, war records, political events, etc. The system includes a pre-processing unit arranged for scanning each record for identifying data-items relating to a plurality of predetermined data types. The plurality of predetermined data types includes all or a sub-set of the above mentioned Elementary Scenario Components: Arena, Time(frame), Context, Protagonist, Antagonist, Motivation, Primary Objective, Means, modus operandi, Resistance, Symbolism, and Red herring of the event. The system includes a classifying unit arranged for assigning to each identified data-item a category value of one of a plurality of predetermined category values associated with said predetermined data-type. The system includes a processing unit arranged for constructing a matrix containing a row for each record, and containing columns related to the predetermined data-types, the cells of the matrix containing the determined category values. The system includes an input unit, arranged for receiving user input, the user input including category values of an event for some, but not all, of the predetermined data types. The system includes a scenario generator arranged for estimating, on the basis of the user input and on the basis of the matrix, a category value for the predetermined data type(s) not included in the user input. The system includes an output unit arranged for outputting the estimated category value for the predetermined data type(s) not included in the user input. It will be appreciated that the specific aspects mentioned above also relate to this general system, mutatis mutandis.

According to the invention is also provided a computer implemented method for anticipating criminal behaviour. The method includes having the computer access a data set including a plurality of records, each record including data representative of a criminal incident. The method includes scanning each record for identifying data-items each relating to one of a plurality of predetermined data types, wherein the plurality of predetermined data types includes all or a sub-set of the above mentioned Elementary Scenario Components: Arena, Time(frame), Context, Protagonist, Antagonist, Motivation, Primary Objective, Means, modus operandi, Resistance, Symbolism, and Red herring of the criminal incident. The method includes assigning to each identified data-item relating to one of the predetermined data-types a category value of one of a plurality of predetermined category values associated with said predetermined data-type. The method includes having the computer construct a matrix wherein each row relates to an individual criminal incident, and wherein each column relates to an individual predetermined data-type, the cells of the matrix containing the determined category values. The method includes having the computer receive a user input, the user input including category values of a criminal incident under investigation for some, but not all, of the predetermined data types. The method includes having the computer estimate, on the basis of the user input and on the basis of the matrix, a category value for the predetermined data type(s) not included in the user input; and having the computer output the estimated category value(s) for the predetermined data type(s) not included in the user input.

### BRIEF DESCRIPTION OF THE DRAWINGS

Embodiments of the present invention will now be described in detail with reference to the accompanying drawings in which:

FIG. 1 is a schematic representation of a system for anticipating criminal behaviour according to the invention.

### DETAILED DESCRIPTION

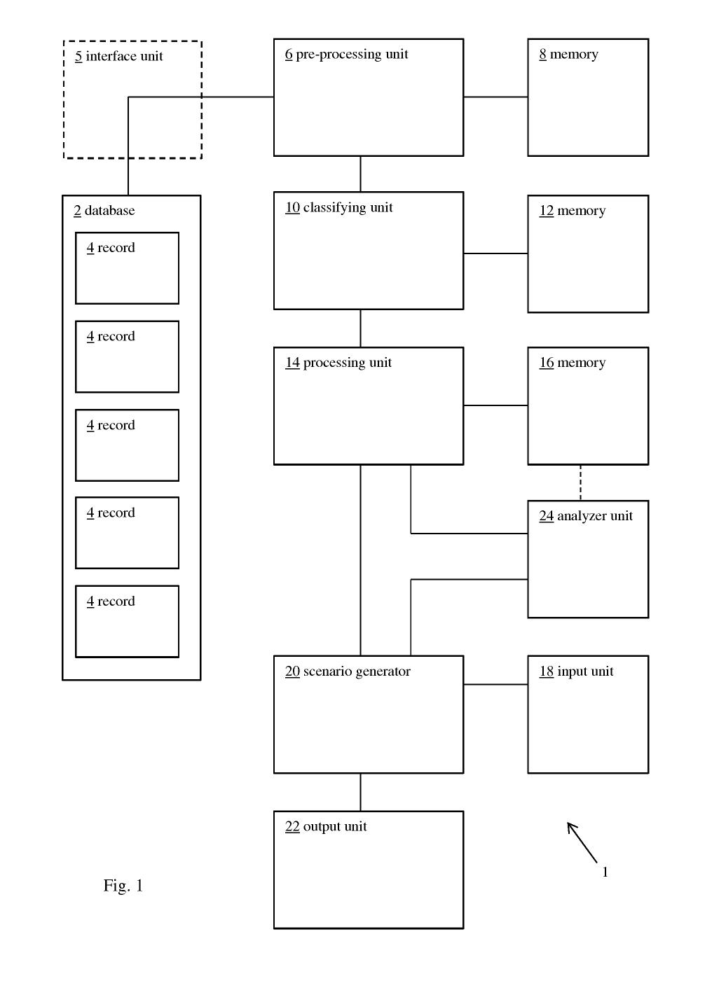

FIG. 1 shows a schematic representation of a system 1 for anticipating criminal behaviour according to the invention. The system 1 is communicatively connected to, or includes, a database 2. The data base 2 includes records 4, each record including data representative of a criminal incident. It will be appreciated that the system may be arranged to cooperate with multiple databases, e.g. including data on lethal criminal violence, gang related data, etc. The database(s) can include records relating to real-life criminal incidents that have happened and have been documented. The database(s) can also include record relating to fictitious criminal incidents, e.g. taken from works of fiction such as movie scripts, theatre productions, TV series, computer game scenarios (e.g. game scenarios being played on consoles or on-line), novels, comics, and the like.

The system 1 includes a pre-processing unit 6, also referred to as data cruncher, arranged for scanning each record 4 for identifying data-items relating to a plurality of predetermined data types. This process is also referred to as data-mining or text-mining. The pre-processing unit 6 is communicatively connected to the database 2, e.g. via an interface unit 5. The data cruncher 6 identifies, in the records 4, data-items that correspond to one of the plurality of predetermined data types. The plurality of predetermined data types includes all or a subset of: Arena, Time(frame), Context, Protagonist, Antagonist, Motivation, Primary Objective, Means, modus operandi, Resistance, Symbolism, Red herring. The definitions of the data types may be stored in a memory 8.

In a first embodiment the plurality of data types includes Arena, Protagonist, Antagonist, and Means. In a second embodiment the plurality of data types includes Arena, Protagonist, Antagonist, Motivation, Means, and modus operandi. In a third embodiment the plurality of predetermined data types includes: Arena, Time(frame), Context, Protagonist, Antagonist, Motivation, Primary Objective, Means, Modus operandi, and Resistance. In a fourth embodiment the plurality of predetermined data types includes: Arena, Time(frame), Context, Protagonist, Antagonist, Motivation, Primary Objective, Means, modus operandi, Resistance, Symbolism, Red herring. A description of these data types is given above. It has been found that these data types offer a durable set of components to describe, characterise, and model a criminal incident.

The system 1 further includes a classifying unit 10 arranged for assigning to each identified data-item a category value of one of a plurality of predetermined category values associated with said predetermined data-type. Hence, the classifying unit 10 receives from the pre-processing unit 6 a data item, and an indication to which data type this data item corresponds. Each data type has associated therewith a plurality of predetermined category values. For example, the data type Arena may have the associated category “Kill zone” which includes the category values “Rural”, “Urban” and “Unspecified”. The classifying unit 10 has knowledge of category values associated with each data type. The categories and category values may be stored in a memory 12. The classifying unit 10 then determines which category value applies to the data item received from the pre-processing unit 6. It will be appreciated that a single category with a plurality of category values can be associated with a data type. It is also possible that a plurality of categories, each having a plurality of category values, is associated with a data type.

The system 1 further includes a processing unit 14 arranged for constructing a matrix containing a row for each record, and containing columns related to the predetermined data-types, the cells of the matrix containing the determined category values. It will be appreciated that if the data type has a single category associated therewith, the matrix includes a singe column for that data type. If the data type has plurality of categories associated therewith, the matrix includes a plurality of columns for that data type. The processing unit may store the matrix in a memory 16.

Thus, the matrix includes homogeneous data that is consistently coded, grouped, and positioned in a relational grid. The data is stored in the matrix in such a fashion that it becomes readily available for analysis. The storage of data in a consistent format allows for rapid comparison of individual historic scenarios. The matrix stores knowledge about the way data is related (i.e., the relation between the data types within an specific scenario). Storing the data in the predetermined data type format preserves the data history, which permits studying the disassembled data types for new and unforeseen correlations, without losing the relation they have with the original context (i.e., the original scenario). The process of warehousing the data stored by category, allows for (i) complex queries, and (ii) the retrieval of information (or meaningful data) from the dataset. For instance, from the data in the Scenario matrix, information on the development of different organisations can be retrieved (such as information on the evolution of Modi operandi over a certain time period).

The system 1 further includes an input unit 18, also referred to as controller, arranged for receiving user input. The user input includes category values of a past, present or future criminal incident for some, but not all, of the predetermined data types. Hence, the input value relates to a narrative of which not all category values for all data types are known.

The system 1 further includes a scenario generator 20 arranged for estimating, on the basis of the user input and on the basis of the matrix, a category value for the predetermined data type(s) not included in the user input. The input unit can e.g. include a keyboard, touch pad, mouse, microphone, data reader, touch screen, or the like.

The system 1 further includes an output unit 22, an arranged for outputting the estimated category value for the predetermined data type(s) not included in the user input. The output unit can e.g. include a display, printer, speaker, data writer, 3d visualization hardware (such as the oculus rift) or the like.

The invention will now be further elucidated referring to FIG. 1. An objective of the invention is to create a scenario model that allows human operators to navigate through the complex territory of criminal behaviour, in order to anticipate future incidents. The scenario model can provide the following advantages. It can offer the possibility to learn from historic criminal behaviour, it can offer the possibility to adapt the chosen strategy on the basis of indicators that are found, and it can offer the possibility to anticipate (unexpected) future real-world behaviour.

Pre-Processing

The preprocessing, preformed by the pre-processing unit 6, relies on a breakdown of historical data contained in the record 4 into the predetermined data types. Pre-processing data into the predetermined data types provides “building blocks” by which classification, ranking, and combination of individual data types is made possible. The predetermined data types will provide the common denominator that facilitates the flow of information between the different stages of the scenario model. Additionally, pre-processing raw data into the predetermined data types allows criminal incidents to be described in a structured and systematic manner. It facilitates (1) the analysis of individual scenarios, (2) the analysis of multiple, idiosyncratic scenarios, and (3) the analysis of idiosyncratic predetermined data types.

Classifying

The classifying, performed by the classifying unit 10 determines for each data item the associated category value. Having identified the category values for the predetermined data types related to a specific incident they can be analysed in an attempt to discover meaningful relations that are relevant in this specific scenario. However, they might also prove to be useful in discovering meaningful relations that transcend the level of individual criminal incidents.

While the particular category values of the predetermined data types of an individual scenario may be analysed, comparing these observations to other scenarios may offer an added value. Accumulating the category values, identified from different incidents, in a systemised way will create a “scenario matrix”, or a two-dimensional (or multi-dimensional) array of Elementary Scenario Components, arranged in rows and columns. Storing the category values of the predetermined data types in a structured way creates a new perspective on the data. For instance, it allows for comparing category values of predetermined data types from incidents that are seemingly not related. It is for instance possible to compare motivations of seemingly unrelated scenarios. The process of pre-processing and classifying historical data in category values of predetermined data types and storing these components in a systemised manner, allows to unveil meaningful findings about the way data is related that could not have been found by traditional analysis of individual scenarios. The discovery of relations in crime-related data gives meaning to that data. This meaning essentially provides information, which subsequently becomes knowledge when it is put into the context of criminal behaviour. This process is quite valuable, both in predictive analysis as well as in intelligence.

Pre-processing and classifying makes use of data-mining techniques. It will be appreciated that data-mining techniques known in the art can be used. Well-known data-mining classifiers that can be used are for instance ZeroR, J48 decision tree, ID3, C4.5, Naïve Bayes, Complement Naïve Bayes, K-Nearest Neighbor, Support Vector Machine, Random Forest Model, Repeated Incremental Pruning to Produce Error Reduction Algorithm (RIPPER), PART (partial decision trees), Multilayer Perceptron. Nevertheless, other data-mining classifiers can be used. These are well known and readily available in the art. The ZeroR classifier identifies the most common class value in a training set and returns that value when evaluating an instance. For example, if data encompasses 55% class A, 40% class B, and 5% class C, then the ZeroR classifier would identify 55% of the instances correctly. Though there is no predictive power in ZeroR, it is useful for determining a baseline performance as a benchmark for other classification methods. The J48 classifier builds decision trees from a set of labelled training data, using the concept of information entropy. It uses the fact that each feature of data can be used to make a decision by splitting the data into smaller subsets, one subset for every value (or range of values) of the feature. The splitting procedure stops if all variables in a subset belong to the same class. The complexity (depth) of a decision tree may be reduced by removing sub-trees and replacing them by leaves. Subsequently, the decision tree removes sections of the tree that provide little power to classify instances. A suitable data-mining tool is Weka (e.g. for Mac).

It will be appreciated that in a practical embodiment it may be made possible also to enter a set of data-items forming a scenario into the matrix by manual input via an input device such as a keyboard.

Anticipation

Anticipation in this context encompasses the analysis of current and historical facts to make predictions about future events. It relies on meaningful relationships, captured from past occurrences, to predict future trends and behaviour.

Based on the scenarios in the database 2, i.e. relations between different category values of predetermined data types within each individual scenario can be determined. Correlations, trends or rules in such relations can be determined. Also relations between the same data types within different scenarios can be determined. Correlations, trends or rules in such relations can be determined.

Anticipation of a future criminal event is required when category values of one or more predetermined data types of a narrative are missing. Using the correlations, trends or rules determined from the scenarios in the database, category values for these missing ones can be extrapolated. These extrapolated category values can be assumed to be valid for this future scenario until proven wrong by further investigation. Alternatively, or additionally, these extrapolated category values can serve as initial estimates for further investigation to uncover more category values from intelligence. The process of anticipation may be exploited to generate actionable output in a law-enforcement context.

Formally, a historic scenario can be referred to as p. The predetermined data types of scenario p are referred to as xᵢ. In the above mentioned embodiments i=1 . . . 6, or 1 . . . 10, or 1 . . . 12. The value of xᵢ refers to the category value of the i^{th} predetermined data type. Consequently, the historic scenario p may be denoted as follows.

p(xᵢ)

In case of a collection of historic scenarios, each scenario of the collection may be denoted as pⱼ in which j=1 to m, and m refers to the total amount of different scenarios in the collection. This collection of historic scenarios can e.g. be rows of the scenario matrix. Consequently, a collection of historic scenarios may formally be denoted as follows.

pⱼ(xᵢ)

The scenario q refers to a new or future incident, which evidently comprises the same set of predetermined data types, which we will denote as yᵢ. Consequently, the new scenario q may be denoted as follows.

q(yᵢ)

So far, one category value has been represented for a scenario by pⱼ(xᵢ). The next step is to evaluate the data type xᵢ under the scenario pⱼ. This can be done by evaluating the function E. So, we then arrive at

E(pⱼ(xᵢ)) in which E denotes the function Evaluate

Instead of, or in addition to, evaluating one data type xᵢ under a scenario pⱼ, we can also evaluate all data types under the scenario pⱼ. This leads to

E_{A}(pⱼ(x)) in which E_{A} denotes the function Evaluate all, and x means (x₁, x₂, . . . x₁₂).

An analyzer unit 24 can for instance determine a relationship between

E_{A}(pⱼ(x)) and Σᵢ₌₁ⁿE(pⱼ(xᵢ)).

Alternatively, or additionally, the analyzer unit 24 can determine a relationship between

E_{A}(pⱼ(X)) and Σⱼ₌₁^{m}Σᵢ₌₁ⁿE(pⱼ(xᵢ)).

The Ability to Learn

The ability to learn refers to (1) the analysis of individual scenarios, (2) the analysis of multiple, idiosyncratic scenarios, and (3) the analysis of idiosyncratic data types. The formal description of the individual scenarios is fairly straightforward: p(xᵢ) in which i=[1 . . . 12]. The formal description of the analysis of multiple, idiosyncratic scenarios is the next step. It refers to the analysis of pⱼ(xᵢ) in which j=[1 . . . m] and i=[1 . . . 12]. For instance, one could analyse any 1 . . . 12 of the components xᵢ of the scenarios pⱼ present in the collection p, or one could analyse the sets of equal category values xᵢ of every i=1 . . . 12 of the scenarios pⱼ present in the collection p.

The Ability to Adapt

The ability to adapt refers to the situation in which appropriate action is required to an actual situation. In this case, historic scenarios may be studied for similarities to the present (unfolding) scenario, called q. To measure the similarity between (the category values of the predeterminjed data types of) two scenarios, one could, for instance, analyse the Euclidean distance (i.e., the “ordinary” distance) between two points, provided that measurement rules have been designed and applied. The person skilled in the art can easily provide such measurement rules. Moreover, in that case, one might measure the cosine of the angle between two vectors pⱼ(xᵢ) and q(yᵢ) with j=1 . . . m and i=1 . . . 12.

The Ability to Anticipate

The ability to anticipate is based on analysing the scenario collection p for similar category values for their respective data types. When a new scenario arises (i.e., when an incident recently took place), category values of a number of the predetermined data types may be known, while category values of the remaining data types remain unknown. In such a new case, we may identify the category values of historic scenarios p, that resemble the new scenario q, e.g. by selecting the scenarios pⱼ in which d(x,y) is minimal. In the scenarios pⱼ, we may use the data types that appear in x and not in y, to anticipate scenario q by the following rule.

Find all pⱼ(x) for a given y in which d(x,y)<r, with r being the threshold.

Moreover, we may use the category values x that appear frequently in the historic scenarios pⱼ, to anticipate the current scenario q by the following rule.

Of all retrieved pⱼ(x) determine per data type xᵢ, which category values appear frequently.

Feedback

The output of the scenario model is presented in predetermined data type format (i.e., in the form of scenarios that constitute a combination of the predetermined data types). This format allows for a seamless introduction of the outputted scenario back into the Scenario matrix to accumulate the number of scenarios present in the matrix. The process of introducing newly generated scenarios into the ESC12 scenario model is defined as the process of Feedback. It is possible that on the basis of the user input (an incomplete scenario) a category value for the predetermined data type(s) not included in the user input is generated, so as to complete the scenario (e.g. all twelve Elementary Scenario Components are either known or estimated). Such completed scenario can be entered into the matrix as well to increase the number of scenarios in the matrix.

It is also possible to use artificial intelligence techniques (such as Case-based Reasoning (CBR)), which gather data or knowledge from the scenarios in the matrix, and build new (fictitious) scenarios according to that data or knowledge. These new scenarios can be added to the matrix. Consequently, the matrix can include (a) historic data relating to real-life incidents, (b) data related to fictitious incidents taken from works of fiction, and/or (c) data related to incidents that are generated by the system itself.

Applying Knowledge

The process of Applying knowledge refers to exploiting knowledge (i.e., data with a meaning and information, within a context) that is latently present within the scenario model. For instance, when the analysis of historic scenarios produces additional, and previously unknown knowledge, this knowledge may be fed back into the system. The process of introducing newly ascertained knowledge into the scenario model is defined as the process of Applying knowledge.

In essence, the processes of Feedback, and that of Applying knowledge, provide for a scenario model that is in a continuous state of learning, augmenting the data, the information, and the knowledge.

The Consistency of Data

The database can contain records that include data from various sources an in various formats. The records may be in the form of narratives, lists, summaries or the like. The records may include restricted data and/or publicly available data. Different sources do not always provide the same data on the same topic. Also the same source may provide inconsistent or contradictory data. The classifying unit can be arranged such that when a record includes contradictory information, the facts supported by the majority of the sources are chosen. Also the analyzer unit may be arranged to reject contradictory information, and e.g. accept facts supported by the majority of the sources.

The predetermined data types mentioned above are the main categories on which the scenario model is based. Taken together, they form the narrative or scenario of an event. For some application, the predetermined data types are too broad to be represented by a single category of category values to allow proper analysis. In such cases it may be beneficial to associate a plurality of categories, or sub data types, to a single data type.

In the following example, every data type is divided into a set of variables. It will be appreciated that beside categories, the variables may also include non-categories such as text entries or numerical entries. Effectively, these variables and their internal structure will guide the pre-processing of data that takes place in the pre-processing unit 6. In the below tables an exemplary set of variables is listed for each predetermined data type. Each table contains a header indicating the predetermined data type. It is noted that “general information” is not one of the predetermined data types, but can usefully be used to provide summary information to human readers. Machine readers (i.e. the system 1) can use the case ID of a record for tracking purposes. Each table includes a first column indicating the number of the variable for that data type. The second column indicates the variable. The third column provides an explanatory note about the nature of the variable. The fourth column indicates whether the variable is a category, dichotomous, text or numerical. The fifth column lists the category values separated by semi-colons. It is noted that the category values are given in interpretable text. It will be appreciated that a concordance may be given turning the category values into numbers, e.g. integer values. The matrix preferable stores the numerical category values to save space and processing time.

0. General Information

| | | | Type of | |
|---|---|---|---|---|
| # | Variable | Explanatory note | variable | Category values |
| 1 | Case ID | Label of incident | Text | |
| 2 | Attack | Classification of | Category | Assassination; Armed |
| | type | incident | | assault; |
| | | | | Bombing/explosion; |
| | | | | Hijacking; Hostage |
| | | | | taking (barricade |
| | | | | incident); |
| | | | | Hostage taking |
| | | | | (kidnapping); Facility/ |
| | | | | infrastructure attack; |
| | | | | Unarmed assault; |
| | | | | Unspecified |
| 3 | Back- | Short summary of | Text | |
| | ground | incident | | |
| 4 | Successful | Was the incident | Dichotomous | Yes; No; |
| | incident | regarded | | |
| | | successful? | | |
| 5 | Sources | Sources of | Text | |
| | | information that | | |
| | | were used to | | |
| | | obtain infor- | | |
| | | mation about | | |
| | | the incident | | |

1. Arena

| | | | Type of | |
|---|---|---|---|---|
| # | Variable | Explanatory note | variable | Category values |
| 1 | Region | In which region did | Category | North America Canada |
| | | the incident take | | Mexico United States; |
| | | place? | | Central Americ & |
| | | | | Caribbean; South |
| | | | | America; East Asia; |
| | | | | Southeast Asia; South |
| | | | | Asia; Central Asia; |
| | | | | Western Europe; Eastern |
| | | | | Europe; Middle Ease & |
| | | | | North Africa; Sub-Sharan |
| | | | | Africa; Russia & the |
| | | | | Newly Independent States; |
| | | | | Australia & Oceania |
| 2 | Country | In which country | Category | |
| | | did the incident | | |
| | | take place? | | |
| 3 | City | In which city did | Text | |
| | | the incident take | | |
| | | place? | | |
| 4 | Kill zone | Was the arena rural | Dichotomous | Urban; Rural; Unspecified |
| | | or urban? | | |
| 5 | Static location | At which type of | Category | Home address; |
| | | static location did | | Workplace; Social |
| | | the incident take | | location; Hotel/Motel; |
| | | place? | | Other; N.A.; Unspecified |
| 6 | En route | On which type of | Category | Home - Work (or vice |
| | | route did the | | versa); Home - Social (or |
| | | incident take | | vice versa); Work - Social |
| | | place? | | (or vice versa); Work - |
| | | | | Work; Social - Social; |
| | | | | N.A.; Unspecified |
| 7 | Public | Was the route/ | Dichotomous | Public route/location; No |
| | route/location | static public | | public route/location; |
| | | location known? | | Unspecified |
| 8 | Description of | Additional | Text | |
| | arena | description related | | |
| | | to the Elementary | | |
| | | Scenario | | |
| | | Component Arena | | |
| 9 | Symbolism | Is a symbolic value | Text | |
| | | associated with the | | |
| | | Elementary | | |
| | | Scenario | | |
| | | Component Arena? | | |
| 10 | Red Herring | Is a Red herring | Text | |
| | | associated with the | | |
| | | Elementary | | |
| | | Scenario | | |
| | | Component Arena? | | |

2. Time(frame)

| | | | Type of | |
|---|---|---|---|---|
| # | Variable | Explanatory note | variable | Category values |
| 1 | Day of the | Which day of the | Category | Monday; Tuesday; |
| | week | week did the event | | Wednesday; |
| | | take place? | | Thursday; Friday; |
| | | | | Saturday; Sunday |
| 2 | Date | Day/Month/Year | Numeric | dd/mm/yyyy |
| 3 | Time | Hour.minutes/ | Numeric | hh:mm |
| | | AM-PM | | |
| 4 | Description | Additional | Text | |
| | of | description of | | |
| | time(frame) | the Elementary | | |
| | | Scenario | | |
| | | Component | | |
| | | Time(frame) | | |
| 5 | Symbolism | Is a symbolic value | Text | |
| | | associated with the | | |
| | | Elementary | | |
| | | Scenario | | |
| | | Component | | |
| | | Time(frame)? | | |
| 6 | Red herring | Is a Red herring | Text | |
| | | associated with the | | |
| | | Elementary | | |
| | | Scenario | | |
| | | Component | | |
| | | Time(frame)? | | |

3. Context

| | | | Type of | |
|---|---|---|---|---|
| # | Variable | Explanatory note | variable | Category values |
| 1 | Type of | What was the | Category | Political; Economical; |
| | context | type of context | | Religious; Personal; |
| | | of the event? | | Miscellaneous; |
| | | | | Unspecified |
| 2 | Description | Additional | Text | |
| | of type of | description of | | |
| | context | the Elementary | | |
| | | Scenario | | |
| | | Component | | |
| | | Context | | |

4. Protagonist

| | | | Type of | |
|---|---|---|---|---|
| # | Variable | Explanatory note | variable | Category values |
| 1 | Confirmed | Is the protagonist | Dichotomous | Confirmed; Unconfirmed |
| | protagonist | known? | | |
| 2 | Number of | Number of | Numeric | # |
| | protagonists | protagonists that | | |
| | involved | were involved | | |
| 3 | Number of | Number of | Numeric | # |
| | protagonists | protagonists that | | |
| | captured | were captured | | |
| 4 | Number of | Number of | Numeric | # |
| | protagonist | protagonists | | |
| | fatalities | involved/Number | | |
| | | of protagonists that | | |
| | | died during | | |
| | | incident | | |
| 5 | Incident | Name of | Text | |
| | attributed to | protagonist(s) | | |
| 6 | Description of | Additional | Text | |
| | background of | description of the | | |
| | protagonist | Elementary | | |
| | | Scenario | | |
| | | Component | | |
| | | Protagonist | | |
| 7 | Incident | Who claimed the | Text | |
| | claimed by | incident? | | |
| 8 | Description of | Additional | Text | |
| | claim of | description of the | | |
| | incident | claim of the | | |
| | | incident | | |
| 9 | Mode of claim | By which mode | Category | Telephone call; Letter; |
| | of | was the incident | | Note left at scene; Note |
| | responsibility | claimed? | | left elsewhere; E-mail; |
| | | | | Video; Posting at website; |
| | | | | Personal claim; Other; |
| | | | | Unspecified |
| 10 | Description of | Additional | Text | |
| | claim of | description of the | | |
| | responsibility | claim of | | |
| | | responsibility | | |
| 11 | Leakage | Did any form of | Dichotomous | Leakage; No leakage; |
| | | leakage precede the | | Unspecified |
| | | incident | | |
| 12 | Description of | Description of | Text | |
| | leakage | leakage | | |
| 13 | Protagonist's | What was the | Dichotomous | Male; Female; |
| | gender | gender of the | | Unspecified |
| | | protagonist? | | |
| 14 | Age(group) | To what age group | Category | 0-10 years; 11-20; 21-30; |
| | | does the | | 31-40; 41-50; 51-60; 61- |
| | | protagonist fit? | | 70; 71-80; 81-90; 91-100; |
| | | | | Miscellaneous; |
| | | | | Unspecified |
| 15 | Terrorist | Was the | Category | {standardised list of group |
| | organisation | protagonist known | | names established by |
| | | member of a | | GTD} |
| | | terrorist | | |
| | | organisation? | | |
| 16 | Description of | Additional | Text | |
| | terrorist | description of the | | |
| | organisation | terrorist | | |
| | | organisation | | |
| 17 | Nature of | What is the nature | Category | Nationalistic; Religious; |
| | incident | of the incident? | | Ideological; lone operator; |
| | | | | Miscellaneous; |
| | | | | Unspecified |
| 18 | Description of | Additional | Text | |
| | nature of | description of the | | |
| | incident | nature of the | | |
| | | incident | | |
| 19 | Background/ | Significant | Text | |
| | history | information about | | |
| | | the background/ | | |
| | | history of the | | |
| | | protagonist | | |
| 20 | Part of | Was the incident | Dichotomous | Part of multiple-incident; |
| | multiple- | part of a multiple- | | Not part of multiple- |
| | incident | incident? | | incident |
| 21 | Description of | Additional | Text | |
| | multiple- | description of other | | |
| | incident | incidents related to | | |
| | | the protagonist or | | |
| | | incident | | |
| 22 | Known | Information about | Text | |
| | previous | previous incidents | | |
| | incidents | related to the | | |
| | | protagonist or the | | |
| | | terrorist | | |
| | | organisation | | |
| 23 | Known | Information about | Text | |
| | subsequent | subsequent | | |
| | incidents | incidents related to | | |
| | | the protagonist or | | |
| | | the terrorist | | |
| | | organisation | | |
| 24 | Ties with third | Are there ties | Dichotomous | Ties with third parties; No |
| | parties | between the | | ties with third parties; |
| | | protagonist and | | Unspecified |
| | | third parties? | | |
| 25 | Description of | Additional details | Text | |
| | ties with third | of ties between the | | |
| | parties | protagonist and | | |
| | | third parties | | |
| 26 | Red herring | Is a Red herring | Text | |
| | | associated with the | | |
| | | Elementary | | |
| | | Scenario | | |
| | | Component | | |
| | | Protagonist? | | |

5. Antagonist

| | | | Type of | |
|---|---|---|---|---|
| # | Variable | Explanatory note | variable | Category values |
| 1 | Primary target | Was the antagonist | Dichotomous | Person; Object |
| | | a person or an | | |
| | | object? | | |
| 2 | Number of | The number of | Numeric | # |
| | antagonist(s) | known antagonists | | |
| | involved | involved in the | | |
| | | incident | | |
| 3 | Specific/ | Was/were the | Dichotomous | Specific; Generic; |
| | generic | antagonist(s) | | Unspecified |
| | antagonist(s) | selected randomly | | |
| | | or selectively from | | |
| | | a target | | |
| | | population? | | |
| 4 | Selection of | What was the | Category | Significance of |
| | antagonist(s) | possible rationale | | antagonist(s); |
| | | behind the | | Vulnerability of |
| | | selection of | | antagonist(s); Level of |
| | | antagonist(s)? | | grievance; Level of |
| | | | | exposure; Significant date |
| | | | | event; Iconic value of |
| | | | | antagonist; Miscellaneous; |
| | | | | Unspecified |
| 5 | Type of | What category can | Category | Business; Government |
| | antagonist(s) | be assigned to the | | (general); Police; Military; |
| | | Type of | | Abortion related; Airports |
| | | antagonist(s)? | | & airlines; Government |
| | | | | (diplomatic); Educational |
| | | | | institution; Food or water |
| | | | | supply; Journalist & |
| | | | | media; Maritime; Non |
| | | | | Governmental |
| | | | | Organisations (NGOs); |
| | | | | Private Citizens & |
| | | | | property; Religious figures/ |
| | | | | institutions; |
| | | | | Telecommunication; |
| | | | | Terrorists; Tourists; |
| | | | | Transportation (other than |
| | | | | aviation); Utilities; Violent |
| | | | | political parties; Other; |
| | | | | Unspecified |
| 6 | Description of | Additional | Text | |
| | type of | information about | | |
| | antagonist(s) | the Type of | | |
| | | antagonist(s) and | | |
| | | possible relation to | | |
| | | secondary | | |
| | | antagonist(s) | | |
| 7 | Name of | Name of | Text | |
| | antagonist(s) | antagonist(s) | | |
| 8 | Description of | Description of | Text | |
| | antagonist(s) | antagonist(s) | | |
| 9 | Nationality of | Nationality of | Category | Country code |
| | antagonist(s) | antagonist(s) | | |
| 10 | Symbolism | Is a symbolic value | Text | |
| | | associated with the | | |
| | | Elementary | | |
| | | Scenario | | |
| | | Component | | |
| | | Antagonist? | | |
| 11 | Red herring | Is a Red herring | Text | |
| | | associated with the | | |
| | | Elementary | | |
| | | Scenario | | |
| | | Component | | |
| | | Antagonist? | | |
| 12 | Antagonist(s) | Number of | Numeric | #involved/#died |
| | die(s) from | antagonist(s) that | | |
| | attack | died in relation to | | |
| | | the incident | | |
| | | (#involved/#died) | | |
| 13 | Other fatalities | Were there other | Dichotomous | Other fatalities; No other |
| | | fatalities related to | | fatalities; Unspecified |
| | | the incident? | | |
| 14 | Total fatalities | How many | Numeric | # |
| | | fatalities were | | |
| | | related to the | | |
| | | incident? | | |
| 15 | Other injuries | Where there other | Dichotomous | Other injuries; No other |
| | | casualties related to | | injuries; Unspecified |
| | | the incident? | | |
| 16 | Total injuries | How many | Numeric | #involved/#injured |
| | | casualties were | | |
| | | related to the | | |
| | | incident? | | |
| 17 | Description of | Additional | Text | |
| | fatalities/ | description of | | |
| | injuries | fatalities/injuries | | |

6. Motivation

| | | | Type of | |
|---|---|---|---|---|
| # | Variable | Explanatory note | variable | Category values |
| 1 | Possible | What motivated the | Category | Need; Greed; |
| | motivation | protagonist? | | Power; Moral |
| | | | | outrage; |
| | | | | Glory; Unknown |
| 2 | Description | Additional | Text | |
| | of | description of the | | |
| | motivation | motivation of the | | |
| | | protagonist | | |

7. Primary objective

| | | | Type of | |
|---|---|---|---|---|
| # | Variable | Explanatory note | variable | Category values |
| 1 | Initial | What was the | Category | Applying pressure; |
| | aim of | initial aim the | | Media attention; |
| | the | protagonist had | | Oppression; |
| | protagonist | in relation to | | Emphasising cause; |
| | | the incident? | | Extending influence; |
| | | | | Eliminating |
| | | | | opponent(s); training; |
| | | | | Miscellaneous; |
| | | | | Unspecified |
| 2 | Description | Additional | Text | |
| | of initial | description | | |
| | aim | of the initial | | |
| | | aim of the | | |
| | | protagonist | | |

8. Means

| | | Explanatory | Type of | |
|---|---|---|---|---|
| # | Variable | note | variable | Category values |
| 1 | Type of | Classification of | Category | Assassination/ |
| | incident | type of incident | | liquidation; Armed |
| | | | | assault; Bombing; |
| | | | | Hijacking; Hostage taking/ |
| | | | | Kidnapping; Vehicle |
| | | | | attack; Computer network |
| | | | | attack/electronic warfare; |
| | | | | Chemical, biological, |
| | | | | radiological or nuclear |
| | | | | (CBRN); Other; |
| | | | | Miscellaneous; |
| | | | | Unspecified |
| 2 | Description of | Description of | Text | |
| | incident | means related to | | |
| | | the incident | | |
| 3 | Weapon | Classification of | Category | Biological; Chemical; |
| | category | weapon category | | radiological; Nuclear; |
| | | | | Firearms; Explosives/ |
| | | | | bombs/dynamite; Fake |
| | | | | weapons; Incendiary; |
| | | | | Melee; Vehicle (not to |
| | | | | include vehicle-borne |
| | | | | explosives); Sabotage |
| | | | | equipment; Other; |
| | | | | unspecified |
| 4 | Weapon sub- | Classification of | Category | Biological {—}; Chemical |
| | category | weapon sub- | | {Poisoning}; radiological |
| | | category | | {—}; Nuclear {—}; Firearms |
| | | | | {Automatic weapon; |
| | | | | Handgun; Rifle/shotgun |
| | | | | (non-automatic); |
| | | | | Unknown; other}; |
| | | | | Explosives/bombs/ |
| | | | | dynamite {Grenade; Land |
| | | | | mine; Letter bomb; |
| | | | | Pressure trigger; |
| | | | | Projectile; Remote |
| | | | | trigger; Suicide; Time |
| | | | | fuse; Vehicle; Unknown; |
| | | | | Other}; Fake weapons {—}; |
| | | | | Incendiary {Arson/fire; |
| | | | | Flame thrower; Gasoline |
| | | | | or Alcohol}; Melee {Blunt |
| | | | | object; Hands, feet, fists; |
| | | | | Knife; Strangling device; |
| | | | | Sharp object other than |
| | | | | knife; Suffocation; Other; |
| | | | | Unknown}; Vehicle (not |
| | | | | to include vehicle-borne |
| | | | | explosives) {—}; Sabotage |
| | | | | equipment {—}; Other {—}; |
| | | | | Unspecified {—} |
| 5 | Description of | Description of | Text | |
| | weapon (sub-) | weapon (sub-) | | |
| | category | category | | |
| 6 | Type of | Classification of | Category | {types of explosives from |
| | primary | explosive | | GTD} |
| | explosive | | | |
| 7 | Amount of | Amount of | Numeric | # |
| | primary | explosive used | | |
| | explosive | | | |
| 8 | Detonation | Classification of | Category | Timer; radio frequency; |
| | | detonation of | | Pressure; Manual; Motion |
| | | explosive | | or trip-wire controlled; |
| | | | | Miscellaneous; Other; |
| | | | | Unspecified |
| 9 | Description of | Additional | Text | |
| | explosive | description of | | |
| | | explosive/ | | |
| | | detonation | | |
| 10 | Suicide | Can the incident be | Dichotomous | Suicide mission; no |
| | mission | classified as a | | suicide mission; |
| | | suicide mission/ | | Unspecified |
| 11 | Description of | Additional | Text | |
| | suicide | description of the | | |
| | mission | suicide mission | | |
| 12 | Delivery | In what way was | Category | Ground-based vehicle; |
| | method | the weapon/ | | Water, vessel; Sub aquatic/ |
| | | explosive | | scuba; Aircraft; Missile |
| | | delivered? | | (surface to surface); |
| | | | | Missile (surface to air); |
| | | | | Missile (air to surface); |
| | | | | Missile (air to air); Missile |
| | | | | (unknown type); Suicide |
| | | | | terrorist; Human host; |
| | | | | Mail/post; Food/ |
| | | | | beverages; Water supply; |
| | | | | Gaseous; Miscellaneous; |
| | | | | Unspecified |
| 13 | Description of | Remarks on | Text | |
| | transportation | transportation of | | |
| | | weapons, resources | | |
| | | etc./delivery | | |
| | | method etc. | | |
| 14 | Symbolism | Is a symbolic value | Text | |
| | | associated with the | | |
| | | Elementary | | |
| | | Scenario | | |
| | | Component | | |
| | | Means? | | |
| 15 | Red herring | Is a Red herring | Text | |
| | | associated with the | | |
| | | Elementary | | |
| | | Scenario | | |
| | | Component | | |
| | | Means? | | |

9. Modus operandi

| | | | Type of | |
|---|---|---|---|---|
| # | Variable | Explanatory note | variable | Category values |
| 1 | Level of | What level of | Category | Low; Medium; High; |
| | intelligence | intelligence did the | | Unspecified |
| | | protagonist(s) need | | |
| | | to attain for their | | |
| | | actions? | | |
| 2 | Actual M.O. | Explanation of the | Text | |
| | | M.O. what | | |
| | | happened, in what | | |
| | | order, etc. | | |
| 3 | Pre-incident | Classification of | Category | Weapons/material |
| | action(s) | pre-incident | | movement; Terrorist |
| | | action(s) | | travel; Terrorist training; |
| | | | | Surveillance; Infiltration; |
| | | | | Test of security; |
| | | | | Elicitation; Other; |
| | | | | Miscellaneous; |
| | | | | Unspecified |
| 4 | Description of | Description of pre- | Text | |
| | pre-incident | incident action(s) | | |
| | action(s) | | | |
| 5 | Post-incident | Classification of | Category | Subsequent attack(s); |
| | action(s) | post-incident | | Subsequent action(s); |
| | | action(s) | | Incident claimed; |
| | | | | Successful exfiltration; |
| | | | | Other; Miscellaneous; |
| | | | | Unspecified |
| 6 | Description of | Description of | Text | |
| | post-incident | post-incident | | |
| | action(s) | action(s) | | |
| 7 | Communication | Was there any | Dichotomous | Communication; No |
| | | form of | | communication |
| | | communication | | |
| | | during, before or | | |
| | | after the incident | | |
| 8 | Description of | Description of | Text | |
| | communication | communication | | |
| 9 | Symbolism | Is a symbolic value | Text | |
| | | associated with the | | |
| | | Elementary | | |
| | | Scenario | | |
| | | Component Modus | | |
| | | operandi? | | |
| 10 | Red herring | Is a Red herring | Text | |
| | | associated with the | | |
| | | Elementary | | |
| | | Scenario | | |
| | | Component Modus | | |
| | | operandi? | | |

10. Resistance

| | | | Type of | |
|---|---|---|---|---|
| # | Variable | Explanatory note | variable | Category values |
| 1 | Protection | Did the antagonist | Dichotomous | Protection; No protection |
| | | have any form of | | |
| | | close protection? | | |
| 2 | Driver | Was the antagonist | Dichotomous | Driver; No driver; N.A. |
| | | accompanied by a | | |
| | | driver? | | |
| 3 | Number of | How many | Numeric | # |
| | protectors | protectors were | | |
| | | there? | | |
| 4 | Number of | How many of the | Numeric | #protectors/# armed |
| | armed | protectors were | | |
| | protectors | armed? | | |
| 5 | Procedure | What procedure did | Text | |
| | | the protectors | | |
| | | follow? | | |
| 6 | Category of | What category can | Category | Armoured car class d; |
| | protection | be assigned to the | | Armoured carr class c; |
| | | protection of the | | Armoured car class b; |
| | | antagonist? | | Armoured car class a; |
| | | | | Armoured car class |
| | | | | unknown; Travelling |
| | | | | convoy; Advanced |
| | | | | protection team; Counter |
| | | | | surveillance team; Body |
| | | | | armour; RF jammers; |
| | | | | Other; Unspecified; N.A. |
| 7 | Previous | Has there been an | Text | |
| | security breach | earlier breach in | | |
| | | security? | | |
| 8 | Security | Has there been a | text | |
| | intervention | security | | |
| | | intervention during/ | | |
| | | proceeding/ | | |
| | | preceding the | | |
| | | attack? | | |

In table 8 the weapon sub-categories are indicated in italics and between brackets relative to the overlying weapon category.

The pre-processing unit 6 extracts, from each record 4, data items that correspond to one of the category values of the variables of the data types. These category values are then stored in the matrix as described above.

It is noted that the two predetermined data types Symbolism and Red herring are related to the remaining 10 predetermined data types. In this example, Symbolism and Red herring do not possess idiosyncratic variables and are consequently not included in the above tables, but are part of the set of variables by way of accounting for their relationship to the other predetermined data types.

### Example

This example relates to a situation in which law-enforcement agencies are investigating a terrorist attack that recently occurred. In the process of investigation, law-enforcement agencies have to combine their knowledge of the case that is currently under investigation, with “readily accessible lessons from history”. In this example the five predetermined date types and associated sixteen variables are General info {Successful incident}, Arena {Country}, Time(frame) {Day; Month; Year}, Protagonist {number of protagonists involved; Terrorist organisation; Part of multiple-incident; Ties with third parties}, Antagonist {Type of antagonist: Antagonist dies from attack; Total fatalities; Total injuries}, and Means {Type of incident; Weapon sub-category; Suicide mission}.

In this example, in the hours after a terrorist attack, thirteen of the sixteen variables are (or become) known. The known variables in this example are: Successful incident (1), Country (2) of the attack, Day (3), Month (4), and Year (5) of the attack. Furthermore, we assume that (shortly after the incident) it is known if the attack was Part of a multiple-incident (8), what the Type of antagonist(s) (10) was, and whether Antagonist(s) die(s) from attack (11). With respect to the victims, we assume that shortly after the incident the Total fatalities (12) are known, as well as the Total injuries (13). Finally, in this example the Type of incident (14) is known, as well as the Weapon sub-category (15) that was used and whether the attack could be classified as a Suicide mission (16).

Consequently, it is assumed that the remaining three unknown variables (viz. Number of protagonists (6), Terrorist organisation (7), and Ties with third parties (9)) would provide valuable information for law-enforcement agencies in the investigation of this exemplary terrorist attack that recently occurred.

A database containing 53,289 records of criminal incidents was used in this example. The data items were stored in the described matrix format. Data-mining showed that the J48 decision tree produces a higher accuracy percentage (40.50%) for the variable Number of Protagonists than the baseline classifier ZeroR (30.98%). This result was obtained using a J48 decision tree considering the following six variables respectively: (A) Suicide Mission, (B) Country, (C) Type of antagonist(s), (D) Weapon sub-category, (E) Part of multiple-incident, and (F) Total injuries.

On the basis of the data accumulated in the matrix the J48 decision tree suggests a correlation between the variables Number of protagonists and Suicide Mission. This correlation seems plausible given the fact that most suicide attacks are carefully planned and orchestrated by a larger number of protagonists (larger than one), in order to achieve the most effect. The J48 decision tree also suggests correlation between the variables Number of protagonists and Country. A possible explanation for the influence of the variable Country is that the data accumulated in the matrix indicate a relation between certain countries and the number of protagonists. This might be due to the fact that lone-operator attacks relatively frequently take place in certain western countries. In contrast, data in the matrix suggests that in countries with, for instance a (civil) war,

attacks are generally executed by a larger number of protagonists than average. The relation between Number of protagonists and Type of antagonist(s) may be explained by the fact that certain target types require a specific amount of protagonists. For instance, “Military” type targets usually require a large(r) number of protagonists in order to be successful. The correlation between the variables Number of protagonists and Weapon subcategory, may be best explained by an example: If the Weapon sub-category is “Hands, feet, fists”, then the number of protagonists is usually relatively small. Consequently, if the Weapon sub-category is “Radiological”, or “Nuclear”, this is a strong indicator that more than one protagonist is involved. The variable Part of multiple-incident holds a rather obvious relation to Number of protagonists. It indicates that the majority of the cases in the matrix that constitute multiple-incidents, are related to more (than one) protagonist(s). It seems obvious that for multiple-incidents to happen at the same time, more protagonists are required. The fact that the J48 decision tree of the variable Number of protagonists considers the variable Total injuries, indicates that the number of protagonists and the number of injuries are related. This may be explained by the probable assumption that two protagonists (with weapons from a certain Weapon subcategory) can generate more injuries than one protagonist (with the same weapon).

On the basis of these correlations, the system now determines a most likely value for the variable Number of Protagonists. It is also possible that the system determines a, e.g. ordered, list of likely values for the variable Number of protagonists.

Similarly, for the variable Terrorist organisation the J48 algorithm in this example produces a considerably higher accuracy percentage (68.52%) than the baseline (6.80%). This result is attained by a decision tree that considers the four variables (A) Country, (B) Type of antagonist(s), (C) Year, and (D) Part of multiple-incident.

A: Country,

The correlation between the variables Terrorist organisation and Country confirms the notion of counter-terrorism organisations that terrorist organisations operate in a geographically confined area (which do not necessarily have to be their “homecountries”). The J48 decision tree indicates a correlation between the variables Terrorist organisation and Type of antagonist(s). This correlation may be best explained by an example: The three most classified types of antagonist concerning terrorist organisations are (1) Corsican National Liberation Front which exclusively aims at types of antagonist classified as “Government (general)” (2) Hizbul Mujahideen which primarily aims at types of antagonist classified as “Military”, and (3) the Muttahida Qami Movement which aims at types of antagonist classified as “Private citizens & property”. The J48 decision tree of the variable Type of antagonist(s) indicates that terrorist organisations are active within a certain timeframe. On the basis of the data accumulated in the matrix, the J48 decision tree correlates the variables Terrorist organisation and Part of multiple-incident. This concurs with the prominent notion of counter terrorism organisations. In this notion, a specific tactic (such as organising a terrorist attack around multiple incidents) is closely related to certain terrorist organisations.

Similarly, The J48 algorithm produces a notably higher accuracy percentage (68.40%) for the variable Ties with third parties than the ZeroR classifier (6.81%). This result is generated by a decision tree that considers five variables (A) Country, (B) Type of antagonist(s), (C) Year, (D) Antagonist(s) die(s) from attack, and (E) Part of multiple-incident.

The first three “leaf nodes” of the decision tree generated for the variable Ties with third parties are the same as in the decision tree as discussed for the variable Terrorist organisation. Therefore, refer to the above discussion of the variables Country, Type of antagonist(s), and Year in the decision process. The correlation between the variable Ties with third parties and the variable Antagonist(s) die(s) from attack may be explained by the fact that the Modus operandi of the terrorist organisation and the parties they are related with, are closely correlated. In other words, terrorist organisations which are associated with one another, frequently use a similar Modus operandi in which the antagonist often dies from an attack. In congruence with the variable Antagonist(s) die(s) from attack discussed above, the correlation between the variable Ties with third parties and Part of multipleincident may be explained by the fact that the Modus operandi of the terrorist organisation and the parties they are related with, are correlated.

The example illustrates the applicability of data-mining classifiers. The tests in the example were performed with rather straightforward data-mining classifiers. Evidently much more elaborate data-mining classifiers can be applied. Such more elaborate data-mining classifiers can enhance the efficiency and effectivity of the system.

Other Uses of the Invention

The system and method have been described in relation to anticipating criminal behaviour. It will be appreciated that the system and method can also be put to use for anticipating other types of human behaviour. The inventor realised that most human behaviour can be described in narratives. Therefore, such narratives relating to human behaviour can be mapped onto the predetermined data types defined herein. Hence, these narratives can be broken down into category values relating to the twelve Elementary Scenario Components, or to category values relating to a subset of these twelve Elementary Scenario Components.

The system can e.g. be used for anticipating human behaviour in the field of tourism, travelling, insurance, fraud, negotiation, litigation, consumer behaviour, gaming industry, politics, warfare, coups d'état, geopolitical developments, etc.

For example, in the fields of tourism and travelling the Arena (e.g. travel from where to where), Time(frame) (e.g. when, which holidays, how long), Protagonist (e.g. age, gender, nationality, social class), Motivation (e.g. relaxation, business, sight-seeing), Means (e.g. accommodation, means of transportation), and others of the twelve predetermined data types determine the scenario of behaviour. Using historical real-life data, and optionally data from works of fiction, relating to tourism and travelling allows the system to anticipate tourism and travelling behaviour in a manner similar as described above in relation to anticipating criminal behaviour.

For example in the field of insurance, in particular insurance claims, the Arena (e.g. country of insured party, country of incident), Time(frame) (e.g. when, holiday), Context (e.g. medical incident, material damage), Protagonist (e.g. claimant/insurance company, claim history, gender, age), Antagonist (e.g. claimant/insurance company, claim history, gender, age), Primary Objective (e.g. support, services, compensation), Resistance (e.g. counter-indications), and others of the twelve predetermined data types determine the scenario of behaviour. Using historical real-life data, and optionally data from works of fiction, relating to insurance allows the system to anticipate insurance behaviour in a manner similar as described above in relation to anticipating criminal behaviour.

For example in the field of fraud the Arena (e.g. country), Time(frame) (e.g. when, how long), Context (e.g. nature of fraud), Protagonist (e.g. gender, age, nationality, private/corporate), Antagonist (e.g. gender, age, nationality, private/corporate), Primary Objective (e.g. services, money, extortion), Modus Operandi (e.g. internet, impersonating, bookkeeping), Red Herring (e.g. false leads), and others of the twelve predetermined data types determine the scenario of behaviour. Using historical real-life data, and optionally data from works of fiction (such as movie scripts, TV series, theater productions, novels), relating to fraud allows the system to anticipate fraud behaviour in a manner similar as described above in relation to anticipating criminal behaviour.

For example in the field of negotiation the Arena (e.g. country of party, country of counter party), Time(frame) (e.g. when, for how long), Protagonist (e.g. private/corporate, type of business, corporate function, age, time of job experience), Antagonist (e.g. private/corporate, type of business, corporate function, age, time of job experience), Primary Objective (e.g. buy, sell, take-over, hire, fire), Means (e.g. money, services), Modus Operandi (e.g. hostile negotiation, friendly negotiation), Resistance (e.g. unwilling counter party, lack of funds), Symbolism (e.g. sentimental value), Red Herring (e.g. negotiation tricks), and others of the twelve predetermined data types determine the scenario of behaviour. Using historical real-life data, and optionally data from works of fiction, relating to negotiations allows the system to anticipate negotiation behaviour in a manner similar as described above in relation to anticipating criminal behaviour.

For example in the field of litigation the Arena (e.g. country, court), Time(frame) (e.g. when), Context (e.g. criminal litigation, civil litigation), Protagonist (e.g. plaintiff/defendant, age, private/corporate), Antagonist (e.g. plaintiff/defendant, age private/corporate), Primary Objective (e.g. damages, relief), Motivation (e.g. justice, grudge, compensation), Modus Operandi (e.g. hostile/friendly), Resistance (e.g. jury, witness), Symbolism (e.g. justice), Red Herring (e.g. perjury), and others of the twelve predetermined data types determine the scenario of behaviour. Using historical real-life data, and optionally data from works of fiction (such as movie scripts, TV series, theater productions, novels), relating to litigation allows the system to anticipate litigation behaviour in a manner similar as described above in relation to anticipating criminal behaviour.

For example in the field of consumer behaviour, for instance commericials, advertisement, the Arena (e.g. country, audience, target group), Time(frame) (e.g. when), Context (e.g. product development, sales, after-sales), Protagonist (e.g. manufacturer, retailer, age, size), Antagonist (e.g. consumer, target group, age, gender), Primary Objective (e.g. brand awareness, sales), Modus Operandi (e.g. TV commercial, in-show advertisement, newspaper, radio, handout, internet), Resistance (e.g. consumer test results, price war), and others of the twelve predetermined data types determine the scenario of behaviour. Using historical real-life data, and optionally data from works of fiction, relating to consumption allows the system to anticipate consumption behaviour in a manner similar as described above in relation to anticipating criminal behaviour.

For example in the field of gaming industry, particularly game design, the Arena (e.g. in what “country” or “world” is the game set), Time(frame) (e.g. past/present/future/fiction), Protagonist (e.g. type of “hero”), Antagonist (e.g. adversaries in the game), Primary Objective (e.g. aim of the game), Modus Operandi (e.g. racing, shooting, puzzles), and others of the twelve predetermined data types determine the scenario of behaviour. Using data relating to existing games, as well as historical real-life data, and optionally data from works of fiction (such as movie scripts, TV series, theater productions, novels, other games) relating to themes suitable for games, allows the system to generate scenarios for novel games in a manner similar as described above in relation to anticipating criminal behaviour.

For example in the field of warfare the Arena (e.g. country, terrain), Time(frame) (e.g. when, how long), Context (e.g. invasion, defense, peace mission), Protagonist (e.g. agressor/defender/peacekeeper, troop size), Antagonist (e.g. agressor/defender/peacekeeper, troop size), Primary Objective (e.g. occupy, liberate, pressure), Motivation (e.g. greed, religious, moral), Modus Operandi (e.g. air/water/ground), Resistance (e.g. terrain, international pressure), and others of the twelve predetermined data types determine the scenario of behaviour. Using historical real-life data, and optionally data from works of fiction (such as movie scripts, TV series, theater productions, novels, computer games), relating to warfare allows the system to anticipate warfare behaviour in a manner similar as described above in relation to anticipating criminal behaviour.

For example in the field of politics, e.g. geopolitical developments, the Arena (e.g. country, region), Time(frame) (e.g. when, how long), Context (e.g. regional politics, political crises, elections), Protagonist (e.g. politician, political group, the people, activists), Antagonist (e.g. politician, political group, the people, activists), Primary Objective (e.g. win elections, pass law), Motivation (e.g. justice, welfare, career), Modus Operandi (e.g. debate, smear campaign), Resistance (e.g. counter parties), and others of the twelve predetermined data types determine the scenario of behaviour. Using historical real-life data, and optionally data from works of fiction (such as movie scripts, TV series, theater productions, novels), relating to politics allows the system to anticipate political behaviour in a manner similar as described above in relation to anticipating criminal behaviour.

It will be appreciated that the categories underlying the twelve predetermined data types may be different and suited to the particular field of anticipating and the particular data set being used. Therefore, the 98 potential variables identified in view of anticipating criminal behaviour might, partially, be discarded and other variables might be added, in view of the data set being used.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the above example, a set of variables is recited for ten of the predetermined data types. It will be appreciated that it is also possible to only use the categorial and/or dichotomous variables of such set. It is also possible to add additional variables if the data set so requires. It is also possible to delete variables if these prove useless in view of the data set. It is also possible to split variables into a plurality of variables if this enhances the level of detail of the analysis. It is also possible to use only the variables of a reduced set of predetermined data types, such as Arena, Protagonist, Antagonist, Motivation, Means and Modus Operandi. It is also possible to use a subset of the variables as shown in the above example. It is for instance possible to use the following variables: Arena {Region; Kill zone; Static location; En route; Public route/location}; Protagonist {Confirmed protagonist; Description of background; Protagonist's gender; Protagonist's age(group}; Antagonist {Specific/Generic antagonist(s); Type of antagonist(s); Symbolism}; Motivation {Possible motivation of protagonist; description of motivation of protagonist}; Means {Type of incident; Weapon sub-category}; and Modus operandi {Level of intelligence}. It will be appreciated that the interface unit, pre-processing unit, classifying unit, processing unit, scenario generator, and analyzer unit can be embodied as dedicated electronic circuits, possibly including software code portions. The interface unit, pre-processing unit, classifying unit, processing unit, scenario generator, and analyzer unit can be embodied as dedicated electronic circuits, possibly including software code portions can also be embodied as software code portions executed on, and e.g. stored in, a memory of, a programmable apparatus such as a computer.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program.

For example, the carrier may comprise a non-transitory storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means, e.g. via the internet or cloud.

When a program is embodied in a signal which may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

In the above examples, the matrix is arranged in rows and columns. It will be appreciated that the rows may be horizontal and the columns vertical, or vice versa. It will also be appreciated that the matrix is a representation of storage of category values in a computer memory. The matrix may also be stored in the memory as a linear list of category values, e.g. indexes as a matrix, or as dispersed entries, e.g. indexed as a matrix.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A system for anticipating criminal behaviour including:
a pre-processing unit connectable to a database including records, each record including data representative of a criminal incident, the pre-processing unit being arranged for scanning each record for identifying data-items relating to a plurality of predetermined data types, wherein the plurality of predetermined data types includes all or a sub-set of: Arena, Time(frame), Context, Protagonist, Antagonist, Motivation, Primary Objective, Means, Modus operandi, Resistance, Symbolism, and Red herring of the criminal incident;
a classifying unit arranged for assigning to each identified data-item a category value of one of a plurality of predetermined category values associated with said predetermined data-type;
a processing unit arranged for constructing a matrix containing a row for each record, and containing columns related to the predetermined data-types, the cells of the matrix containing the determined category values;
an input unit, arranged for receiving user input, the user input including category values of a criminal incident for some, but not all, of the predetermined data types;
a scenario generator arranged for estimating, on the basis of the user input and on the basis of the matrix, a category value for the predetermined data type(s) not included in the user input; and
an output unit arranged for outputting the estimated category value for the predetermined data type(s) not included in the user input.

2. The system of claim 1, wherein the scenario generator is arranged for estimating, on the basis of the user input and on the basis of the matrix, a plurality of category values for the predetermined data type(s) not included in the user input, preferably each with an associated level of confidence.

3. The system of claim 1, further including:
an analyzer unit arranged for analyzing the matrix for determining intra-scenario relationships between category values of different data types within a record and/or inter-scenario relationships between category values of the same data type between records.

4. The system of claim 3, wherein the scenario generator is arranged for estimating a category value for the predetermined data type(s) not included in the user input, on the basis of the user input and on the basis of the intra-scenario and/or inter-scenario relationships.

5. The system of claim 1, wherein the scenario generator is arranged for estimating a category value for all predetermined data types not included in the user input.

6. The system of claim 5, wherein the output unit is arranged for outputting a scenario including the user input and the estimated category values for all predetermined data types not included in the user input.

7. The system of claim 6, wherein the output unit is arranged for adding the scenario including the user input and the estimated category values for all predetermined data types not included in the user input to the matrix.

8. The system of claim 1, further including:
an analyzer unit arranged for analyzing the matrix and determining new scenarios based on the matrix, and for adding these new scenarios to the matrix.

9. The system of claim 1, further including:
an analyzer unit arranged for interpreting the user input as a vector, for interpreting each row of the matrix as a vector, and for determining the row(s) having an associated vector ending at a Euclidian distance from the endpoint of the vector associated with the user input, such that this distance is smaller than a predetermined threshold value.

10. The system of claim 9, wherein the analyzer unit further is arranged for determining the row(s) having an associated vector ending at the smallest Euclidian distance from the endpoint of the vector associated with the user input.

11. The system of claim 1, wherein the database includes records representative of a real-life criminal incidents and fictitious criminal incidents.

12. The system of claim 1, wherein at least one of the data types of the plurality of predetermined data types includes a plurality of sub data types, each sub data type having a plurality of predetermined category values associated therewith.

13. A system for anticipating behaviour including:
a database including records, each record including data representative of an event,
a pre-processing unit arranged for scanning each record for identifying data-items relating to a plurality of predetermined data types, wherein the plurality of predetermined data types includes all or a sub-set of: Arena, Time(frame), Context, Protagonist, Antagonist, Motivation, Primary Objective, Means, modus operandi, Resistance, Symbolism, and Red herring of the event;
a classifying unit arranged for assigning to each identified data-item a category value of one of a plurality of predetermined category values associated with said predetermined data-type;
a processing unit arranged for constructing a matrix containing a row for each record, and containing columns related to the predetermined data-types, the cells of the matrix containing the determined category values;
an input unit, arranged for receiving user input, the user input including category values of an event for some, but not all, of the predetermined data types;
a scenario generator arranged for estimating, on the basis of the user input and on the basis of the matrix, a category value for the predetermined data type(s) not included in the user input; and
an output unit arranged for outputting the estimated category value for the predetermined data type(s) not included in the user input.

14. The system of claim 13, wherein the system is arranged for anticipating human behaviour in one or more of the fields of crime, tourism, travelling, insurance, fraud, negotiation, litigation, consumer behaviour, gaming industry, warfare, politics, coups d'état, and geopolitical developments.

15. A computer implemented method for anticipating criminal behaviour including:
having the computer access a data set including a plurality of records, each record including data representative of a criminal incident,
scanning each record for identifying data-items each relating to one of a plurality of predetermined data types, wherein the plurality of predetermined data types includes all or a sub-set of: Arena, Time(frame), Context, Protagonist, Antagonist, Motivation, Primary Objective, Means, modus operandi, Resistance, Symbolism, and Red herring of the criminal incident;
assigning to each identified data-item relating to one of the predetermined data-types a category value of one of a plurality of predetermined category values associated with said predetermined data-type;
having the computer construct a matrix wherein each row relates to an individual criminal incident, and wherein each column relates to an individual predetermined data-type, the cells of the matrix containing the determined category values;
having the computer receive a user input, the user input including category values of a criminal incident under investigation for some, but not all, of the predetermined data types;
having the computer estimate, on the basis of the user input and on the basis of the matrix, a category value for the predetermined data type(s) not included in the user input; and
having the computer output the estimated category value(s) for the predetermined data type(s) not included in the user input.

16. The method of claim 15, wherein the scenario generator is arranged for estimating, on the basis of the user input and on the basis of the matrix, a plurality of category values for the predetermined data type(s) not included in the user input, preferably each with an associated level of confidence.

17. The method of claim 15, further including:
having the computer analyze the matrix for determining intra-scenario relationships between category values of different data types within a record and/or inter-scenario relationships between category values of the same data type between records, and estimate a category value for the predetermined data type(s) not included in the user input, on the basis of the user input and on the basis of the intra-scenario and/or inter-scenario relationships.

18. The method of claim 15, further including having the computer estimate a category value for all predetermined data types not included in the user input

19. The method of claim 18, further including having the computer outputting the scenario including the user input and the estimated category values for all predetermined data types not included in the user input to a user, or introducing said scenario into the matrix.

20. The method of claim 15, further including having the computer analyze the matrix, determine new scenarios based on the matrix, and add these new scenarios to the matrix.

21. The method of claim 11, further including:
having the computer interpret the user input as a vector, interpret each row of the matrix as a vector, and determine the row(s) having an associated vector ending at a Euclidian distance from the endpoint of the vector associated with the user input, such that this distance is smaller than a predetermined threshold value, and estimate (a) category value(s) for the predetermined data type(s) not included in the user input, on the basis of the user input and on the basis of the distance.

22. The method of claim 12, further including having the computer determine the row(s) having an associated vector ending at the smallest Euclidian distance from the endpoint of the vector associated with the user input.

23. The method of claim 15, further including performing a criminal incident risk analysis by creating a risk analysis query by formulating a user input including category values of a virtual criminal incident for some, but not all, of the predetermined data types.

24. The method of claim 15, further including using the estimated category value(s) for the predetermined data type(s) not included in the user input as input for further investigation of the criminal incident under investigation.

25. The method of claim 15, wherein at least one of the data types of the plurality of predetermined data types includes a plurality of sub data types, each sub data type having plurality of predetermined category values associated therewith.

26. A computer implemented method for behaviour including:
having the computer access a data set including a plurality of records, each record including data representative of an event,
scanning each record for identifying data-items each relating to one of a plurality of predetermined data types, wherein the plurality of predetermined data types includes all or a sub-set of: Arena, Time(frame), Context, Protagonist, Antagonist, Motivation, Primary Objective, Means, modus operandi, Resistance, Symbolism, and Red herring of the event;
assigning to each identified data-item relating to one of the predetermined data-types a category value of one of a plurality of predetermined category values associated with said predetermined data-type;
having the computer construct a matrix wherein each row relates to an individual event, and wherein each column relates to an individual predetermined data-type, the cells of the matrix containing the determined category values;
having the computer receive a user input, the user input including category values of an event under investigation for some, but not all, of the predetermined data types;
having the computer estimate, on the basis of the user input and on the basis of the matrix, a category value for the predetermined data type(s) not included in the user input; and
having the computer output the estimated category value(s) for the predetermined data type(s) not included in the user input.

27. The method of claim 26, wherein the events relate to one or more of crime, tourism, travelling, insurance, fraud, negotiation, litigation, consumer behaviour, gaming industry, warfare, politics, coups d'état, and geopolitical developments.

28. A non-transitory computer readable medium storing computer implementable instructions which when implemented by a programmable computer cause the computer to:
access a matrix wherein each row relates to an individual event, and wherein each column relates to one of a plurality of predetermined data-types, wherein the plurality of predetermined data types includes all or a sub-set of: Arena, Time(frame), Context, Protagonist, Antagonist, Motivation, Primary Objective, Means, modus operandi, Resistance, Symbolism, and Red herring of the event, wherein each predetermined data type has associated therewith a plurality of predetermined category values, wherein the cells of the matrix contain category values for the specific predetermined data type and event;
request a user input, the user input including category values of an event under investigation for some, but not all, of the predetermined data types;
estimate, on the basis of the user input and on the basis of the matrix, a category value for the predetermined data type(s) not included in the user input; and
output the estimated category value(s) for the predetermined data type(s) not included in the user input.
